(19) United States
(12) Patent Application Publication
(10) Pub. No.: US 2018/0150562 A1
(43) Pub. Date: May 31, 2018

(54) System and Method for Automatically Extracting and Analyzing Data

(71) Applicant: Cognizant Technology Solutions India Pvt. Ltd., Chennai (IN)

(72) Inventors: Venugopal Gundimeda, Telangana (IN); Ramakrishna Polepalli, Telangana (IN); Prakash Adidam, Telangana (IN); Varahala Raju Penumatsa, Telangana (IN); Ajay Prashanth, Telangana (IN); Sankar Narayanan Nagarajan, Telangana (IN); Swarnendu Ghosh, Telangana (IN)

(21) Appl. No.: 15/656,439

(22) Filed: Jul. 21, 2017

(30) Foreign Application Priority Data
Nov. 25, 2016 (IN) 201641040344

(51) Int. Cl. G06F 17/30; G06F 17/27

(52) U.S. Cl. CPC G06F 17/30867; G06F 17/2785; G06F 17/2705; G06F 17/30896

(57) ABSTRACT

A system and computer-implemented method for automatically extracting and analyzing data from one or more data sources is provided. The system comprises a platform manager configured to provide options for configuring rules for data extraction. The system further comprises a web scraping and crawling module configured to extract data from one or more data sources by executing one or more data extraction jobs using the configured rules. Furthermore, the system comprises an information extraction engine configured to analyze the extracted data by performing one or more analytical operations, decipher the analyzed data using pre-stored vocabularies and classify the deciphered data. The information extraction engine further configured to convert at least one of: the analyzed data, the deciphered data and the classified data to one or more formats for use by at least one of: one or more enterprise applications, enterprise portals and one or more communication channels.

### FIELD OF THE INVENTION

The present invention relates generally to data sourcing. More particularly, the present invention provides a system and method for automatically extracting and analyzing data from one or more data sources of the World Wide Web.

### BACKGROUND OF THE INVENTION

World Wide Web has enormous amount of data which is accessible via internet. Enterprises require a lot of data available on the World Wide Web in the course of their business. It is important that this data is sourced quickly by enterprises, specially publishing and news agencies, stock brokerage firms and corporates for staying ahead of competition and efficiently running their business.

Conventionally, various systems and methods exist for sourcing data from the World Wide Web. For example, enterprises employ knowledge workers and analysts who search for relevant and credible data available on the World Wide Web. However, manually searching for data on the World Wide Web is a time consuming process. Further, the data searched by the knowledge workers and analysts is prone to inaccuracy. Furthermore, the knowledge workers and analysts spend most of their time searching for data thereby reducing the time devoted to analysis. As a result of inefficient analysis, the searched data is less useful and meaningful to the enterprises.

In light of the above-mentioned disadvantages, there is a need for a system and method for automatically extracting and analyzing data from one or more data sources of the World Wide Web. Further, there is a need for a system and method that accurately extracts relevant data from the World Wide Web based on the context of search. Furthermore, there is a need for a system and method capable of analyzing the extracted data from the World Wide Web thereby making it more useful and meaningful for enterprises. In addition, there is a need for a system and method that minimizes the time and cost required for searching and analyzing the data available on the World Wide Web.

### SUMMARY OF THE INVENTION

A system, computer-implemented method and computer program product for automatically extracting and analyzing data from one or more data sources is provided. The system comprises a platform manager configured to provide one or more options for configuring one or more rules for data extraction. The system further comprises a web scraping and crawling module configured to extract data from one or more data sources by executing one or more data extraction jobs using the one or more configured rules. Furthermore, the system comprises an information extraction engine configured to analyze the extracted data by performing one or more analytical operations, decipher the analyzed data using pre-stored vocabularies and classify the deciphered data. The information extraction engine further configured to convert at least one of: the analyzed data, the deciphered data and the classified data to one or more formats for use by at least one of: one or more enterprise applications, enterprise portals and one or more communication channels.

In an embodiment of the present invention, the one or more data sources comprise websites, webpages, web documents and any other data sources associated with the World Wide Web. In an embodiment of the present invention, the one or more configured rules comprise crawling rules, extraction rules, conversion rules, business rules and navigation rules. In an embodiment of the present invention, the one or more data extraction jobs comprise one or more configuration flows that are executed for data extraction and further wherein the one or more configurations flows are created by associating one or more configurable components with each of the one or more configuration flows. In an embodiment of the present invention, the one or more configurable components associated with each of the one or more configuration flows comprise the one or more configured rules, one or more configurable parameters and one or more analysis components.

In an embodiment of the present invention, the web scraping and crawling module is further configured to rank the extracted data based on at least one of: keyword priorities and priorities assigned to the one or more data sources associated with the one or more data extraction jobs. In an embodiment of the present invention, the one or more analytical operations comprise text analysis, indexing, entity recognition, Part-Of-Speech (POS) tagging, classification and correction, co-reference resolution, automatic linking of phrases and words, auto-reviewing, natural language processing and machine learning. In an embodiment of the present invention, the analyzed data, the deciphered data and the classified data is converted to the one or more formats comprising Comma-Separated Values (CSV) file format, XML format, database file formats, Hyper Text Markup Language (HTML), Portable Document Format (PDF), HTML5, word processing document formats, presentation formats, spreadsheet formats, image formats, video formats and open formats.

In an embodiment of the present invention, the system further comprises a content transformer configured to provide the converted data to at least one of: the one or more enterprise applications, the enterprise portals and the one or more communication channels. In an embodiment of the present invention, the content transformer communicates with one or more communication channels interface for automatically forwarding the converted data to one or more end users in real-time via the one or more communication channels.

The computer-implemented method for automatically extracting and analysing data from one or more data sources, via program instructions stored in a memory and executed by a processor, comprises configuring one or more rules for data extraction. The computer-implemented method further comprises extracting data from one or more data sources by executing one or more data extraction jobs using the one or more configured rules. Furthermore, the computer-implemented method comprises analyzing the extracted data by performing one or more analytical operations, deciphering the analyzed data using pre-stored vocabularies and classifying the deciphered data. In addition, the computer-implemented method comprises converting the analyzed data, the deciphered data and the classified data to one or more formats for use by at least one of: one or more enterprise applications, enterprise portals and one or more communication channels.

The computer program product for automatically extracting and analysing data from one or more data sources comprises a non-transitory computer-readable medium having computer-readable program code stored thereon, the computer-readable program code comprising instructions that when executed by a processor, cause the processor to configure one or more rules for data extraction. The processor is further configured to extract data from one or more data sources by executing one or more data extraction jobs using the one or more configured rules. Furthermore, the processor is configured to analyze the extracted data by performing one or more analytical operations, deciphering the analyzed data using pre-stored vocabularies and classifying the deciphered data. The processor is also configured to convert the analyzed data, the deciphered data and the classified data to one or more formats for use by at least one of: one or more enterprise applications, enterprise portals and one or more communication channels

### BRIEF DESCRIPTION OF THE ACCOMPANYING DRAWINGS

The present invention is described by way of embodiments illustrated in the accompanying drawings wherein:

FIG. 1 is a block diagram illustrating a system for automatically extracting and analyzing data from one or more data sources, in accordance with an embodiment of the present invention;

FIG. 2 is a detailed block diagram illustrating a platform manager, in accordance with an embodiment of the present invention;

FIG. 3 is a block diagram illustrating components of a distributed setup, in accordance with an embodiment of the present invention;

FIG. 4 represents a flowchart illustrating a method for automatically extracting and analyzing data from one or more data sources, in accordance with an embodiment of the present invention; and

FIG. 5 illustrates an exemplary computer system in which various embodiments of the present invention may be implemented.

### DETAILED DESCRIPTION OF THE INVENTION

A system and method for automatically extracting and analyzing data from one or more data sources of the World Wide Web is described herein. The invention provides for a system and method that accurately extracts relevant data from the World Wide Web based on the context of search. The invention further provides for a system and method capable of analyzing the extracted data from the World Wide Web thereby making it more useful and meaningful for enterprises. Furthermore, the invention provides a system and method that minimizes the time and cost required for searching and analyzing data available on the World Wide Web.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

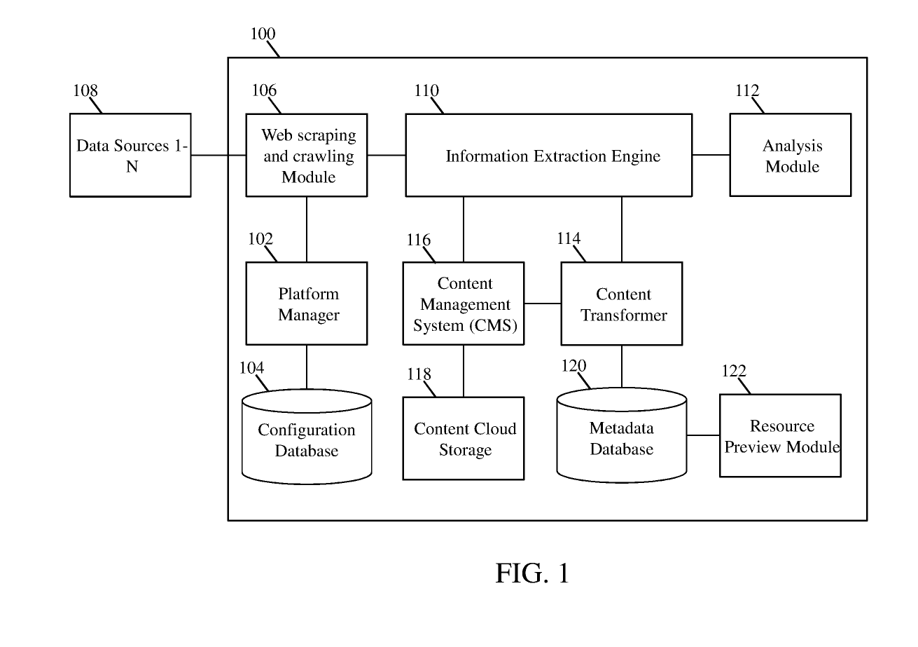

FIG. 1 is a block diagram illustrating a system 100 for automatically extracting and analyzing data from one or more data sources, in accordance with an embodiment of the present invention. The system 100 comprises a platform manager 102, a configuration database 104, a web scraping and crawling module 106, an information extraction engine 110, an analysis module 112, a content transformer 114, a Content Management System (CMS) 116, a content cloud storage 118, a metadata database 120 and a resource preview module 122. The system 100 connects with one or more data sources 108 on World Wide Web via internet. In an embodiment of the present invention, the system 100 is a cloud based system used by one or more enterprises. Further, the system 100 is capable of being accessed from numerous nodes. Furthermore, the system 100 is scalable based on needs and requirements of the one or more enterprises. In another embodiment of the present invention, the system 100 is a standalone system at the one or more enterprises accessible via one or more nodes. In an exemplary embodiment of the present invention, the system 100 is deployed using Amazon Elastic Compute Cloud (EC2). In an embodiment of the present invention, the system 100 uses a relational database management system such as, but not limited to, MySQL.

The platform manager 102 comprises a front-end interface configured to provide one or more options to one or more users to configure one or more rules for extracting data from one or more data sources 108 of the World Wide Web. The one or more rules comprise crawling rules, extraction rules, conversion rules, business rules and navigation rules. Further, the one or more configured rules are modifiable via the platform manager 102 thereby making the system 100 adaptable as per the needs and requirements of the one or more enterprises. The one or more configured rules are stored in the configuration database 104 for use by the web scraping and crawling module 106.

In an exemplary embodiment of the present invention, the one or more users may configure the one or more rules as:

“<include regex=“(?i)(\bpresse\b|\press|\bnews|\barchive|\bannouncement|\bdisclousers\b)” priority=“high”/>”

The abovementioned regex rule extracts hyperlinks and webpages with keywords “press”, “announcements”, “news”, “archive”, “disclosures” occurring in the targeted document or hyperlink. Further, the abovementioned exemplary rule can be applied to any part of the webpage such as, but not limited to, title, text, Header, meta-keywords in the target hypertext document. Furthermore, the one or more configured rules are used during different phases of processing such as crawling, extraction and transformation to perform action relevant to the corresponding phase of the processing.

In an embodiment of the present invention, business rules describe actions such as, but not limited to, extracting, skipping extraction, and injecting one or more modules based on at least type of data source and context of data extraction. In an exemplary embodiment of the present invention, a business rule such as “<inject content-type=“text/javascript” module=“WebApplicationTestingModuleInjector”/>” is used to inject a module such as, but not limited to, web application testing module for Java based websites if the source is a Java script website to extract the rendered data of the webpage. In an embodiment of the present invention, one or more third party modules are used based on the type of data source and/or context of data extraction.

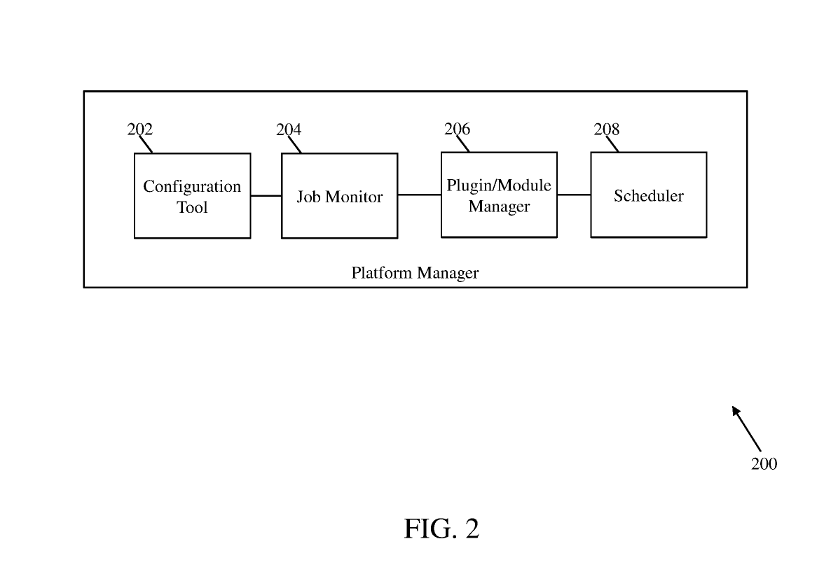

In an embodiment of the present invention, the platform manager 102 also provides one or more options to the one or more users to pre-configure search sources that act as a starting point to begin a search for relevant data. The web scraping and crawling module 106 uses the pre-configured search sources to initiate a search and extract relevant data from the World Wide Web during operation. The platform manager 102 is discussed in detail in conjunction with FIG. 2.

FIG. 2 is a detailed block diagram illustrating a platform manager 200, in accordance with an embodiment of the present invention. The platform manager 200 comprises a configuration tool 202, a job monitor 204, a plugin/module manager 208 and a scheduler 210.

The configuration tool 202 is a web interface that facilitates in configuration of the one or more rules by setting rule format, rule application and priorities. Further, the one or more configured rules facilitate fetching, parsing, analyzing and transforming the data from the one or more data sources 108 (FIG. 1) of the World Wide Web. Furthermore, the one or more rules are configured as XML elements.

In an embodiment of the present invention, each of the one or more rules correspond to one or more configuration flows. The configuration tool 202 allows the one or more users to create the one or more configuration flows by associating one or more configurable components with the one or more configuration flows. The one or more configurable components comprise, but not limited to, one or more configurable parameters, the one or more configured rules and one or more analysis components. In an embodiment of the present invention, the one or more configurable parameters include, but not limited to, crawling time, frequency of crawling, data sources to crawl, starting point of the data sources to crawl and number of pages to crawl. In an embodiment of the present invention, the one or more analysis components facilitate analyzing links, link text, meta keywords, meta description, page content and page title. In an exemplary embodiment of the present invention, each configuration flow has a name such as “NewsPageExtractor” and a corresponding set of rules such as, but not limited to, inject, include, exclude, parse and analyze. In an embodiment of the present invention, the configuration tool 102 facilitates in applying the one or more configured rules on pre-stored lists comprising keywords to include and exclude specific sets of keywords during data extraction.

The job monitor 204 is a monitoring tool used by the one or more users to control one or more data extraction jobs. Further, the one or more data extraction jobs are configured by the one or more users, via the configuration tool 202. The one or more data extraction jobs comprise the one or more configuration flows. Further, the one or more data extraction jobs are executed on multiple machines via the web scraping and crawling module 106 (FIG. 1) for simultaneous and efficient data extraction from corresponding one or more data sources 108 of the World Wide Web. Further, the one or more data extraction jobs comprise the one or more configuration flows that are executed for data extraction. In an embodiment of the present invention, the one or more data extraction jobs include, but not limited, crawling a static website, extracting specific content from a website by navigating through several pages and crawling a java script website. The job monitor 204 communicates via an interface with a health monitor embedded inside the web scraping and crawling module 106 (FIG. 1). The health monitor reports statuses of the one or more data extraction jobs to the job monitor 204. The statuses of the one or more data extraction jobs are then rendered on one or more electronic communication devices (not shown) used to access the system 100 (FIG. 1). In an embodiment of the present invention, the one or more users can view the statuses of the one or more data extraction jobs. Further, the one or more users are provided options to stop, start, reschedule and remove the one or more data extraction jobs that are running and/or scheduled via the job monitor 204.

The plugin/module manager 206 is a resource manager that facilitates controlling various components of the system 100. The scheduler 208 provides options to the one or more users to schedule the one or more data extraction jobs. Further, the scheduler 208 is configured to execute the one or more data extraction jobs based on the schedule. In an embodiment of the present invention, the one or more users can schedule execution of the one or more data extraction jobs at a particular time or periodically after specific intervals of time.

Referring back to FIG. 1, the web scraping and crawling module 106 is configured to extract data from the one or more data sources 108 by executing the one or more scheduled data extraction jobs using the one or more configured rules. The one or more data sources 108 include, websites, webpages, web documents and any other data sources associated with the World Wide Web. In an exemplary embodiment of the present invention, websites of news channels and stock exchanges, subscription databases, product information brochures, electronic mails, journals and publications available on the World Wide Web are data sources 108. Further, the one or more data sources 108 comprise data in various formats and languages including, but not limited to, Hyper Text Markup Language (HTML), Extensible Markup Language, Portable Document Format (PDF), HTML5, word processing document formats such as .txt and .doc, presentation formats such as .ppt and .pptx, spreadsheet formats such as .xls, image formats such as .jpg, video formats and open formats such as rich text format and open office.

In an embodiment of the present invention, the web scraping and crawling module 106 comprise a crawler configured to search through websites and web documents available on the World Wide Web and detect one or more hyperlinks based on the one or more configured rules. The crawler is further configured to analyze the detected hyperlinks based on navigational context and context of the search. Furthermore, the crawler is configured to extract data from pre-defined number of pages as configured by the one or more users during rule configuration.

In an embodiment of the present invention, the web scraping and crawling module 106 comprise a content value extractor configured to extract data from the one or more data sources 108 and aggregate the extracted data. The aggregated data is then indexed and stored for use by one or more end users and downstream enterprise applications. In an embodiment of the present invention, the web scraping and crawling module 106 ranks the extracted data based on at least one of: keyword priorities and priorities assigned to the one or more data sources 108 associated with the one or more data extraction jobs. In an embodiment of the present invention, the extracted data from higher priority sources is considered more relevant.

In an embodiment of the present invention, the web scraping and crawling module 106 comprise an intelligent crawler bot that searches the World Wide Web using a set of pre-configured search sources and detects targeted pages and other web sources. Further, the crawler bot provides a list of targeted links which are further analyzed to extract relevant data. In an embodiment of the present invention, the crawler bot provides the list of targeted links to the crawler and the content value extractor for analysis.

In an embodiment of the present invention, the web scraping and crawling module 106 comprise a script analyzer configured to extract data from webpages that have Java scripts. In an embodiment of the present invention, the web scraping and crawling module 106 comprise an HTML extractor configured to extract data from webpages created using HTML. In an embodiment of the present invention, the web scraping and crawling module 106 comprise a mock browser module configured to facilitate user-like interaction such as, but not limited to, clicks, navigation and form submission on the internet browser. In an embodiment of the present invention, the web scraping and crawling module 106 is configured to perform form submission and input search queries for retrieving dynamic content from websites.

The information extraction engine 110 is configured to receive the extracted data from the web scraping and crawling module 106 and communicate with the analysis module 112 to facilitate analyzing the received data. The analysis module 112 include, but not limited to, a Named Entity Recognizer (NER), a rule processing engine, a set of machine learning classification libraries and a thesaurus for handling pre-stored vocabularies. The analysis module 112 performs one or more analytical operations such as, but not limited to, text analysis, indexing, entity recognition, Part-Of-Speech (POS) tagging, classification and correction, co-reference resolution, automatic linking of phrases and words, auto-reviewing, natural language processing and machine learning on the extracted data to make it more meaningful for the one or more end users. The analysis module 112 also performs deduplication process to filter duplicated data within the extracted data. Further, the analysis module 112 classifies the extracted data particularly if the extracted data is bulky. In an embodiment of the present invention, maximum entropy algorithm is used by the analysis module 112 for classifying and determining topic of the extracted data. In another embodiment of the present invention, the analysis module 112 uses Naïve Bayes classifier and Decision Trees for classifying the extracted data. In an embodiment of the present invention, the analysis module uses Mallet for statistical natural language processing, document classification, clustering, topic modeling, information extraction and other machine learning applications to the extracted data. In an embodiment of the present invention, topic modeling is used to determine different topics of one or more content paragraphs within the extracted data.

In an embodiment of the present invention, the analysis module 112 is configured to decipher at least one of: the extracted data and the analyzed data using pre-stored vocabularies and classify into domain based information. In an exemplary embodiment of the present invention, the pre-stored vocabularies are stored in a triplestore. Further, the triplestore is queried by the analysis module 112 for deciphering the extracted data and the analyzed data. In an embodiment of the present invention, the analysis module 112 also indexes and catalogues the extracted data and the analyzed data. Indexing and cataloguing facilitates in efficient querying and retrieving of the data.

In an embodiment of the present invention, the analysis module 112 is configured to classify at least one of: the extracted data, the analyzed data and the deciphered data into categories/domain such as, but not limited to, company information, news, research and analysis, industry reports, events and filings, corporate actions, patent information, legislative documents, commodities information, stocks information and any other categories.

Once the extracted data is analyzed, deciphered and classified, the information extraction engine 110 converts the analyzed, the deciphered and the classified data into one or more formats that are suitable for use by at least one of: one or more enterprise applications, enterprise portals and one or more communication channels. In an embodiment of the present invention, the information extraction engine 110 converts the extracted data received from the web scraping and crawling module 106 prior to analysis by the analysis module 112.

In an exemplary embodiment of the present invention, the information extraction engine 110 comprise an Optical Character Recognition (OCR) module to convert data extracted from webpages, PDF files, presentations and images. In an embodiment of the present invention, the analyzed, the deciphered and the classified data is converted into one or more formats including, but not limited to, Comma-Separated Values (CSV) file format, XML format, database file formats, Hyper Text Markup Language (HTML), Portable Document Format (PDF), HTML5, word processing document formats such as .txt and .doc, presentation formats such as .ppt and .pptx, spreadsheet formats such as .xls, image formats such as .jpg, video formats and open formats such as rich text format and open office.

Once the data is converted, the converted data is forwarded to the content transformer 114. The content transformer 114 is configured to provide the converted data to at least one of, but not limited to, the one or more enterprise applications, the enterprise portals and the one or more communication channels for use by the one or more end users. In an embodiment of the present invention, the content transformer 114 communicates with one or more communication channels interface for automatically forwarding the converted data to the one or more end users in real-time via the one or more communication channels. In an embodiment of the present invention, the one or more communication channels include, but not limited to electronic mail, instant messaging, facsimile and Short Messaging Service (SMS). In an embodiment of the present invention, the content transformer 114 is configured to forward the converted data, based on classification by the analysis module 112, to a specific target location or end-user. In an embodiment of the present invention, the extracted data, the analyzed data and the converted data is provided in a user-friendly pictorial and graphical form to the one or more end users.

The CMS 116 is configured to store the extracted data, the analyzed data and the converted data. In an exemplary embodiment of the present invention, the CMS 116 is alfresco. In an embodiment of the present invention, the CMS 116 stores data in various formats including, but not limited to, Comma-Separated Values (CSV) file format, XML format, database file formats, Hyper Text Markup Language (HTML), Portable Document Format (PDF), HTML5, word processing document formats such as .txt and .doc, presentation formats such as .ppt and .pptx, spreadsheet formats such as .xls, image formats such as .jpg, video formats and open formats such as rich text format and open office.

The content cloud storage 118 is configured to facilitate archiving of the extracted data, the analyzed data and the converted data. In an exemplary embodiment of the present invention, the content cloud storage 118 used by the system 100 is Amazon S3.

The metadata database 120 is configured to store metadata related to the output of the content transformer 114. In an exemplary embodiment of the present invention, the metadata database 120 is a relational database management system such as, but not limited to, MySQL.

The resource preview module 122 is configured to facilitate the one or more users to view the extracted data, the analyzed data and the converted data in various formats. Further, the one or more users can add, remove, modify and tag contents of the extracted data, the analyzed data and the converted data via the resource preview module 122.

In an embodiment of the present invention, the system 100 facilitates categorizing information based on domains to provide relevant information related to a specific domain. In an exemplary embodiment of the present invention, the analysis module 112 facilitates extracting and analyzing information related to one or more companies. The system 100 extracts company information and its financials from various data sources 108 such as, but not limited to, company websites, government regulatory filings, security filings and news. Further, the system 100 may also provide information related to a company's products, market segments, services and employees.

In another exemplary embodiment of the present invention, the system 100 extracts and analyzes data associated with an industry sector such as, but not limited to, energy sector. Further, the system 100 may provide information related to energy companies, their assets and related news.

In an exemplary embodiment of the present invention, a web document such as an HTML page is crawled by the web scraping and crawling module 106 to extract hyperlinks and text within the HTML page. The information extraction engine 110 then uses decision making algorithms based on language, grammar and the domain of the HTML page. The information extraction engine 110 further performs optical character recognition and converts the extracted data. The CMS 116 and the metadata database 120 stores the HTML page and the extracted text and hyperlinks within the webpage. The information extraction engine 110 uses an advanced link analysis module and a navigation finder to automatically navigate the HTML page and extract targeted information. The information extraction engine 110 also ranks the extracted data based on priority assigned by the advanced link analysis module and keywords provided by the one or more users corresponding to the one or more data extraction jobs while configuring the one or more data extraction jobs. The information extraction engine 110 then communicates with the analysis module 112 comprising the NER, the rule processing engine, the machine learning classification libraries and the thesaurus for handling vocabularies and to process and analyze the extracted data for further use by the one or more end users.

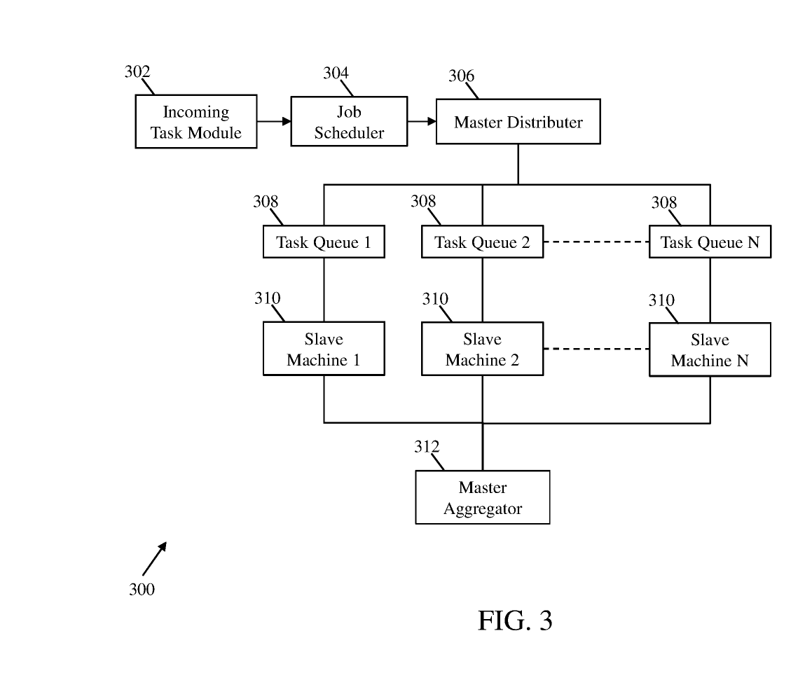

In an embodiment of the present invention, the system 100 has a distributed setup. FIG. 3 is a block diagram illustrating components of the distributed setup, in accordance with an embodiment of the present invention. The distributed setup 300 comprises an incoming task module 302, a job scheduler 304, a master distributor 306, one or more task queues 308, one or more slave machines 310 and a master aggregator 312. In an embodiment of the present invention, the incoming task module 302, the job scheduler 304, the master distributor 306, and the master aggregator 312 reside inside the web scraping and crawling module 106 (FIG. 1). Further, the web scraping and crawling module 106 (FIG. 1) communicates, via the master distributor 306, with the one or more slave machines 310 that are used to access the one or more data sources 108 (FIG. 1) of the World Wide Web.

The incoming task module 302 receives the one or more scheduled data extraction jobs from the platform manager 102 (FIG. 1). Further, the incoming task module 302 forwards the received one or more data extraction jobs to the job scheduler 304.

The job scheduler 304 is configured to communicate with the scheduler 208 (FIG. 2) to schedule the one or more data extraction jobs based on the schedule provided by the one or more users. The job scheduler 208 also provides one or more options to the one or more users to configure parameters such as, but not limited to, crawling time, frequency of crawling, data sources to crawl, starting point of the data sources to crawl and number of pages to crawl.

The master distributer 306 is configured to distribute the one or more data extraction jobs to the one or more slave machines 310. Further, using the one or more slave machines 310 facilitates in concurrently executing the one or more data extraction jobs thereby ensuring that the system 100 (FIG. 1) is distributed and resilient and allowing scaling up for efficient performance and fault tolerance. In an embodiment of the present invention, the master distributor 306 distributes source web URLs to each of the one or more slave machines 310 via the one or more task queues 308 based on one or more pre-stored algorithms. In an exemplary embodiment of the present invention, the master distributor 306 uses round-robin algorithm for distributing the one or more data extraction jobs.

The one or more task queues 308 reside in the one or more slave machines 310. The one or more task queues facilitate distribution of the one or more data extraction jobs to divide load and route messages to the one or more slave machines 310 without data loss.

The one or more slave machines 310 are client devices where the slave components of the distributed setup 300 are deployed. Further, each of the one or more slave machines 310 have corresponding task queue 308. Further, the one or more slave machines 310 execute the one or more data extraction jobs queued in the corresponding task queue 308. In an embodiment of the present invention, new slave machines can be added and existing slave machines may be removed from the distributed setup 300. In an embodiment of the present invention, on completing the queued jobs, the one or more slave machines 310 automatically shut down. Once the one or more data extraction jobs are completed, the control is transferred to the master aggregator 312.

The master aggregator 312 is configured to receive and aggregate the extracted data from the one or more slave machines 310 on completion of the one or more data extraction jobs. The extracted data is then forwarded to the information extraction engine 110 (FIG. 1) for further processing.

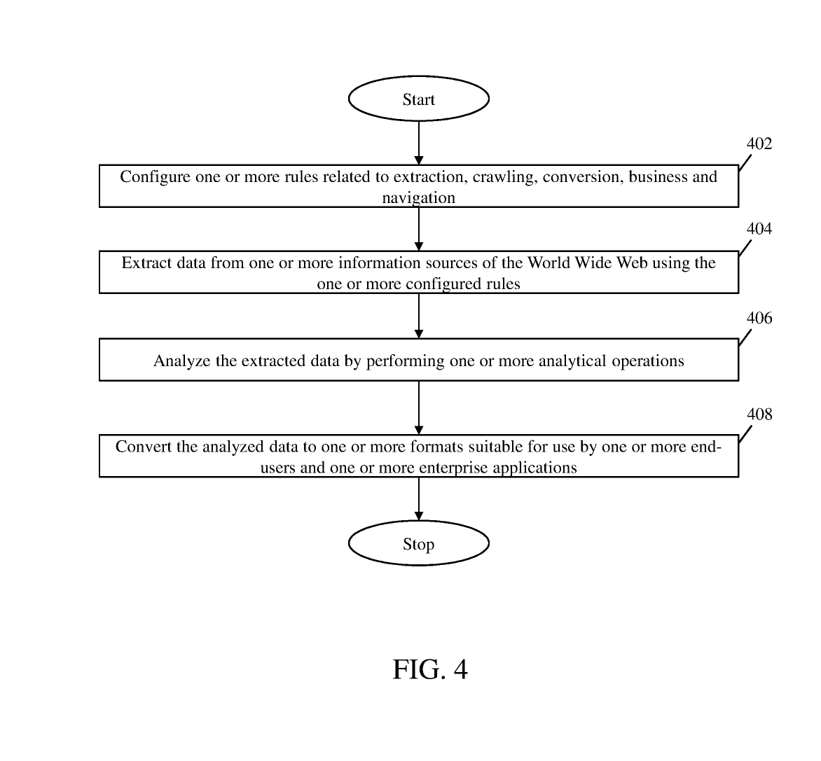

FIG. 4 represents a flowchart illustrating a method for automatically extracting and analyzing data from one or more data sources of the World Wide Web, in accordance with an embodiment of the present invention.

At step 402, one or more rules are configured for extracting data from one or more data sources of the World Wide Web. The one or more rules include, but not limited to, rules related to extraction, crawling, conversion, business and navigation. In an embodiment of the present invention, the one or more rules are configured by one or more users. Further, the one or more configured rules are modifiable based on needs and requirements of one or more enterprises. In an embodiment of the present invention, the one or more data sources comprise websites, webpages, web documents and any other data sources associated with the World Wide Web.

At step 404, data from one or more data sources is extracted by executing one or more data extraction jobs using the one or more configured rules. In an embodiment of the present invention, the one or more data extraction jobs comprise one or more configuration flows that are executed for data extraction. Further, the one or more configurations flows are created by associating one or more configurable components with each of the one or more configuration flows. The one or more configurable components comprise, but not limited to, one or more configurable parameters, the one or more configured rules and one or more analysis components. In an embodiment of the present invention, the one or more configurable parameters include, but not limited to, crawling time, frequency of crawling, data sources to crawl, starting point of the data sources to crawl and number of pages to crawl. In an embodiment of the present invention, the one or more analysis components facilitate analyzing links, link text, meta keywords, meta description, page content and page title. In an exemplary embodiment of the present invention, each configuration flow has a name such as “NewsPageExtractor” and a corresponding set of rules such as, but not limited to, inject, include, exclude, parse and analyze.

In an embodiment of the present invention, the data from the one or more data sources is extracted by a crawler. The crawler is configured to search the one or more data sources and detect one or more documents and one or more hyperlinks based on the one or more configured rules. The crawler is further configured to analyze the detected documents and the detected hyperlinks based on navigational context and context of the search.

In an embodiment of the present invention, during data extraction, a script analyzer is used to extract data from webpages that have Java scripts. In an embodiment of the present invention, an HTML extractor is used to extract data from webpages created using HTML. In an embodiment of the present invention, a mock browser module facilitates user-like interaction such as, but not limited to, clicks, navigation and submission on the internet browser for extracting data from the one or more data sources of the World Wide Web. In an embodiment of the present invention, the crawler is capable of performing form submission and inputting search queries for retrieving dynamic content from websites.

In an embodiment of the present invention, after extraction, the extracted data is ranked based on at least one of: keyword priorities and priorities assigned to the one or more data sources associated with the one or more data extraction jobs.

At step 406, the extracted data is analyzed by performing one or more analytical operations on the extracted data. In an embodiment of the present invention, the one or more analytical operations include, but not limited to, text analysis, indexing, entity recognition, Part-Of-Speech (POS) tagging, classification and correction, co-reference resolution, automatic linking of phrases and words, auto-reviewing, natural language processing and machine learning that facilitate in making the extracted data more meaningful for one or more end users. The one or more analytical operations also include deduplication process to filter duplicated data within the extracted data. In an embodiment of the present invention, the one or more analytical operations are performed using a Named Entity Recognizer (NER), a rule processing engine, a set of machine learning classification libraries and a thesaurus for handling libraries.

In an embodiment of the present invention, the extracted data is classified, particularly if the extracted data is bulky. In an embodiment of the present invention, maximum entropy algorithm is used for classifying and determining topic of the extracted data. In another embodiment of the present invention, Naïve Bayes classifier and Decision Trees are used for classifying the extracted data. In an embodiment of the present invention, Mallet is used for statistical natural language processing, document classification, clustering, topic modeling, information extraction and other machine learning applications on the extracted data. In an embodiment of the present invention, topic modeling is used to determine different topics of one or more content paragraphs within the extracted data.

In an embodiment of the present invention, during analysis, the extracted data and the analyzed data is deciphered using pre-stored vocabularies and classified into domain based information. In an exemplary embodiment of the present invention, the pre-stored vocabularies are stored in a triplestore. Further, the triplestore is queried for deciphering the extracted and the analyzed data. In an embodiment of the present invention, the extracted data is also indexed and catalogued during analysis. Indexing and cataloguing facilitates in efficient querying and retrieving of data.

At step 408, the analyzed data, the deciphered data and the classified data is converted to one or more formats suitable for use by at least one of: one or more enterprise applications, enterprise portals and one or more communication channels. In an embodiment of the present invention, the analyzed data, the deciphered data and the classified data is converted into one or more formats including but not limited to, Comma-Separated Values (CSV) file format, XML format, database file formats, Hyper Text Markup Language (HTML), Portable Document Format (PDF), HTML5, word processing document formats such as .txt and .doc, presentation formats such as .ppt and .pptx, spreadsheet formats such as .xls, image formats such as .jpg, video formats and open formats such as rich text format and open office.

Once the data is converted, the converted data is provided to at least one of: the one or more enterprise applications, the enterprise portal and the one or more communication channels. Further, the converted data is automatically forwarded to one or more end users in real-time via the one or more communication channels. In an embodiment of the present invention, the one or more communication channels include, but not limited to electronic mail, instant messaging, facsimile and Short Messaging Service (SMS). In an embodiment of the present invention, the converted data is forwarded, based on classification of the extracted data during analysis, to a specific target location or one or more end users. In an embodiment of the present invention, the extracted data, the analyzed data and the converted data is provided in a user-friendly pictorial and graphical form to the one or more end users.

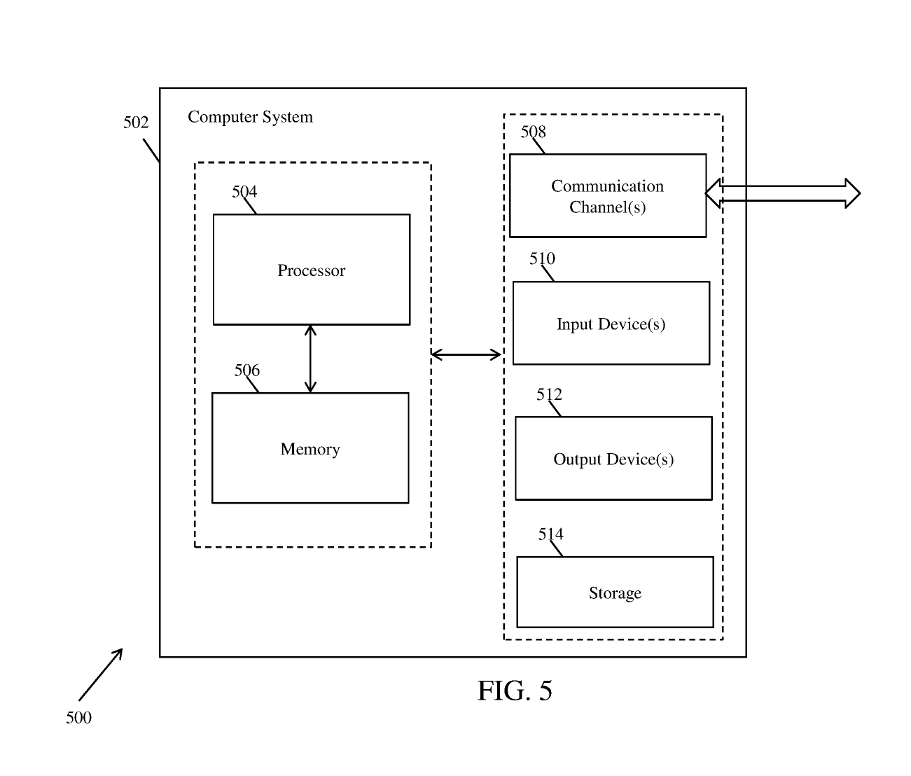

FIG. 5 illustrates an exemplary computer system in which various embodiments of the present invention may be implemented.

The computer system 502 comprises a processor 504 and a memory 506. The processor 504 executes program instructions and may be a real processor. The processor 504 may also be a virtual processor. The computer system 502 is not intended to suggest any limitation as to scope of use or functionality of described embodiments. For example, the computer system 502 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 506 may store software for implementing various embodiments of the present invention. The computer system 502 may have additional components. For example, the computer system 502 includes one or more communication channels 508, one or more input devices 510, one or more output devices 512, and storage 514. An interconnection mechanism (not shown) such as a bus, controller, or network, interconnects the components of the computer system 502. In various embodiments of the present invention, operating system software (not shown) provides an operating environment for various softwares executing in the computer system 502, and manages different functionalities of the components of the computer system 502.

The communication channel(s) 508 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 510 may include, but not limited to, a keyboard, mouse, pen, joystick, trackball, a voice device, a scanning device, or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT or LCD, printer, speaker, CD/DVD writer, or any other device that provides output from the computer system 502.

The storage 514 may include, but not limited to, magnetic disks, magnetic tapes, CD-ROMs, CD-RWs, DVDs, flash drives or any other medium which can be used to store information and can be accessed by the computer system 502. In various embodiments of the present invention, the storage 514 contains program instructions for implementing the described embodiments.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for automatically extracting and analyzing data from one or more data sources, the system comprising:
a platform manager configured to provide one or more options for configuring one or more rules for data extraction;
a web scraping and crawling module configured to extract data from one or more data sources by executing one or more data extraction jobs using the one or more configured rules;
an information extraction engine configured to:
analyze the extracted data by performing one or more analytical operations, decipher the analyzed data using pre-stored vocabularies and classify the deciphered data; and
convert at least one of: the analyzed data, the deciphered data and the classified data to one or more formats for use by at least one of: one or more enterprise applications, enterprise portals and one or more communication channels.

2. The system of claim 1, wherein the one or more data sources comprise websites, webpages, web documents and any other data sources associated with the World Wide Web.

3. The system of claim 1, wherein the one or more configured rules comprise crawling rules, extraction rules, conversion rules, business rules and navigation rules.

4. The system of claim 1, wherein the one or more data extraction jobs comprise one or more configuration flows that are executed for data extraction and further wherein the one or more configurations flows are created by associating one or more configurable components with each of the one or more configuration flows.

5. The system of claim 4, wherein the one or more configurable components associated with each of the one or more configuration flows comprise the one or more configured rules, one or more configurable parameters and one or more analysis components.

6. The system of claim 1, wherein the web scraping and crawling module is further configured to rank the extracted data based on at least one of: keyword priorities and priorities assigned to the one or more data sources associated with the one or more data extraction jobs.

7. The system of claim 1, wherein the one or more analytical operations comprise text analysis, indexing, entity recognition, Part-Of-Speech (POS) tagging, classification and correction, co-reference resolution, automatic linking of phrases and words, auto-reviewing, natural language processing and machine learning.

8. The system of claim 1, wherein the analyzed data, the deciphered data and the classified data is converted to the one or more formats comprising Comma-Separated Values (CSV) file format, XML format, database file formats, Hyper Text Markup Language (HTML), Portable Document Format (PDF), HTML5, word processing document formats, presentation formats, spreadsheet formats, image formats, video formats and open formats.

9. The system of claim 1 further comprising a content transformer configured to provide the converted data to at least one of: the one or more enterprise applications, the enterprise portals and the one or more communication channels.

10. The system of claim 9, wherein the content transformer communicates with one or more communication channels interface for automatically forwarding the converted data to one or more end users in real-time via the one or more communication channels.

11. A computer-implemented method for automatically extracting and analysing data from one or more data sources, via program instructions stored in a memory and executed by a processor, the computer-implemented method comprising:
configuring one or more rules for data extraction;
extracting data from one or more data sources by executing one or more data extraction jobs using the one or more configured rules;
analyzing the extracted data by performing one or more analytical operations, deciphering the analyzed data using pre-stored vocabularies and classifying the deciphered data; and
converting the analyzed data, the deciphered data and the classified data to one or more formats for use by at least one of: one or more enterprise applications, enterprise portals and one or more communication channels.

12. The computer-implemented method of claim 11, wherein the one or more data sources comprise websites, webpages, web documents and any other data sources associated with World Wide Web.

13. The computer-implemented method of claim 11, wherein the one or more configured rules comprise crawling rules, extraction rules, conversion rules, business rules and navigation rules.

14. The computer-implemented method of claim 11, wherein the one or more data extraction jobs comprise one or more configuration flows that are executed for data extraction and further wherein the one or more configurations flows are created by associating one or more configurable components with each of the one or more configuration flows.

15. The computer-implemented method of claim 14, wherein the one or more configurable components associated with each of the one or more configuration flows comprise the one or more configured rules, one or more configurable parameters and one or more analysis components.

16. The computer-implemented method of claim 11 further comprising a step of ranking the extracted data based on at least one of: keyword priorities and priorities assigned to the one or more data sources associated with the one or more data extraction jobs.

17. The computer-implemented method of claim 11, wherein the one or more analytical operations comprise text analysis, indexing, entity recognition, Part-Of-Speech (POS) tagging, classification and correction, co-reference resolution, automatic linking of phrases and words, auto-reviewing, natural language processing and machine learning.

18. The computer-implemented method of claim 11, wherein the analyzed data, the deciphered data and the classified data is converted to the one or more formats comprising Comma-Separated Values (CSV) file format, XML format, database file formats, Hyper Text Markup Language (HTML), Portable Document Format (PDF), HTML5, word processing document formats, presentation formats, spreadsheet formats, image formats, video formats and open formats.

19. The computer-implemented method of claim 11 further comprising a step of providing the converted data to at least one of: the one or more enterprise applications, the enterprise portal and the one or more communication channels.

20. The computer-implemented method of claim 19, wherein the converted data is automatically forwarded to one or more end users in real-time via the one or more communication channels.

21. A computer program product for automatically extracting and analysing data from one or more data sources, the computer program product comprising:
a non-transitory computer-readable medium having computer-readable program code stored thereon, the computer-readable program code comprising instructions that when executed by a processor, cause the processor to:
configure one or more rules for data extraction;
extract data from one or more data sources by executing one or more data extraction jobs using the one or more configured rules;
analyze the extracted data by performing one or more analytical operations, deciphering the analyzed data using pre-stored vocabularies and classifying the deciphered data; and
convert the analyzed data, the deciphered data and the classified data to one or more formats for use by at least one of: one or more enterprise applications, enterprise portals and one or more communication channels.
